(19) United States
(12) Patent Application Publication
(10) Pub. No.: US 2025/0058255 A1
(43) Pub. Date: Feb. 20, 2025

(54) FILTER ASSEMBLY AND FILTER COMPONENT HAVING DETENT CLIPS AND POSTS FOR CLICK-LOCK ENGAGEMENT

(71) Applicant: Caterpillar Inc., Peoria, IL (US)

(72) Inventors: Stephen E. Oedewaldt, Mapleton, IL (US); Jon T. Immel, Chilicothe, IL (US)

(73) Assignee: Caterpillar Inc., Peoria, IL (US)

(21) Appl. No.: 18/234,970

(22) Filed: Aug. 17, 2023

(51) Int. Cl. B01D 29/96; B01D 29/11; B01D 35/00; F01M 11/03

(52) U.S. Cl. CPC B01D 29/96; B01D 29/11; B01D 35/005; F01M 11/03; B01D 2201/4084; B01D 2201/4092

(57) ABSTRACT

A filter assembly for a fluid system such as an oil system for an engine includes a first filter component having a first threaded peripheral surface and a plurality of posts projecting from a radially extending surface. The filter assembly further includes a second filter component including a second threaded peripheral surface and a plurality of detent clips matched to the plurality of posts in number and in angular spacing around the center axis. At least one of, the plurality of posts or the plurality of detent clips, is deformable in a radial direction via relative rotation of the detent clips together about the center axis to click-lock engage the detent clips with the posts.

### TECHNICAL FIELD

The present disclosure relates generally to a filter assembly for a fluid system, and more particularly to an attachment strategy for a serviceable filter component employing detent clips and posts for click-lock engagement.

### BACKGROUND

Filter systems for a variety of fluids are used across a range of industries. In the machinery field, fluid filters are well known for engine oil systems, hydraulic systems, fuel systems, and many others. In most applications, filters accumulate debris over time necessitating cleaning, or more commonly replacement, of a filter element. Time spent servicing machinery generally equates to time that a machine is not productively operating, thus there has long been recognition for the benefits of efficiency in swapping out or servicing parts in a filter system. Moreover, proper positioning and installation of filter components can be critical as improper installation can lead to leaks, or in some cases serious performance degradation or damage to the machinery.

Replaceable filters including engine oil filters and others commonly employ a threaded interface between a receiving component mounted to a machine and a filter component that can be spun on or spun off via the threaded engagement for servicing. Rotating the replaceable filter element can be time consuming, labor intensive, and in some instances difficult. Furthermore, installation mistakes can occur respecting the use of a prescribed installation torque or installation orientation of a filter component. For these and other reasons the industry has recognized a need for improved efficiency in filter servicing as well as positive feedback to a technician that installation is performed properly. One example of an arrangement of connecting features for filter installation and deinstallation is set forth in commonly owned U.S. patent application Ser. No. 18/167, 920 to Finn, filed Feb. 13, 2023.

### SUMMARY

In one aspect, a filter assembly for a fluid system includes a first filter component defining a center axis, and including a first threaded peripheral surface circumferential of the center axis, a radially extending surface, and a plurality of posts projecting from the radially extending surface in an axial direction. The filter assembly further includes a second filter component having a second threaded peripheral surface structured to engage the first threaded peripheral surface, and a plurality of detent clips matched to the plurality of posts in number and in angular spacing around the center axis. The plurality of posts define a first circle centered on the center axis, the plurality of detent clips define a second circle centered on the second axis, and a post-detent interference distance is defined along the radial direction between the first circle and the second circle. At least one of, the plurality of posts or the plurality of detent clips, is deformable via relative rotation of the plurality of detent clips together about the center axis in contact with the plurality of posts to click-lock engage the plurality of detent clips with the plurality of posts.

In another aspect, a filter component includes a filter connector piece defining a center axis extending between a first axial connector end and a second axial connector end. The first axial connector end includes a threaded peripheral surface including threads thereon, a radially extending surface, an axially extending surface, and a plurality of detent clips attached to at least one of the radially extending surface or the axially extending surface. The plurality of detent clips each include a detent surface extending linearly in an axial direction, and contoured radially so as to form a radially projecting engagement bump and a retention pocket circumferentially adjacent to the radially projecting engagement bump.

In still another aspect, a filter component includes a filter housing having a container piece and a filter connector piece, and a filter medium positioned at least partially in the container piece. The filter connector piece defines a center axis extending between a first axial connector end and a second axial connector end. The first axial connector end includes a threaded peripheral surface including multi-start threads thereon, a radially extending surface and an axially extending surface. The filter connector piece further includes a plurality of posts projecting from the radially extending surface in an axial direction and positioned at a clearance from the axially extending surface.

### BRIEF DESCRIPTION OF DRAWINGS

FIG. 1 is a diagrammatic view of a filter assembly, according to one embodiment;

FIG. 2 is a sectioned side diagrammatic view of a filter assembly as in FIG. 1;

FIG. 3 is another diagrammatic view, in perspective, of a filter component, according to one embodiment;

FIG. 4 is a diagrammatic view, in perspective, of another filter component; according to one embodiment;

FIG. 5 is a diagrammatic view, in perspective, of a filter component, according to another embodiment;

FIG. 6 is a diagrammatic view of a filter assembly at one stage of assembly; and

FIG. 7 is a diagrammatic view of the filter assembly of FIG. 6 at another stage of assembly.

### DETAILED DESCRIPTION

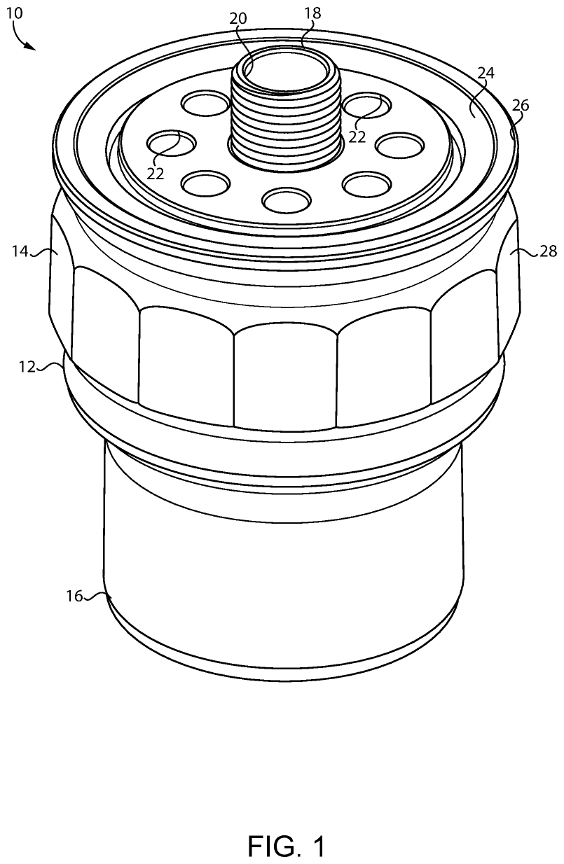

Referring to FIG. 1, there is shown a filter assembly 10 for a fluid system, according to one embodiment. Filter assembly 10 may be implemented in a variety of fluid systems without regard to application or fluid type. In a practical implementation strategy filter assembly 10 is used in an engine oil system to filter engine oil for lubricating and cooling an internal combustion engine, such as a compression-ignition diesel engine or a spark-ignited gaseous fuel engine. In other instances, filter assembly 10 might be used in a hydraulic system, a transmission system, a brake system, a fuel system, or still others. Filter assembly 10 includes a filter housing 12. Filter housing 12 includes a first filter housing component 14 attached to a second filter housing component 16 by way of filter engagement structures not visible to FIG. 1. In an implementation, first filter component 14 includes a connector piece such as a filter head piece or the like that is attached to an engine housing, mounting bracket, or other structure associated with an internal combustion engine. Second filter component 16 may include a container piece 16 containing a filter medium as will be further apparent from the following description. Filter assembly 10 also includes a threaded fitting 18 to be engaged with a mating threaded receptacle supported on or near an engine housing. Also in a practical implementation filter component 14 can remain attached to an engine system while second filter component 16 is removed and swapped out for a replacement component as also further discussed herein. As will be further apparent from the following description filter assembly 10 is uniquely configured for attachment between respective filter components including providing an audible and/or tactile indication to a service technician when a replacement filter element has been installed for service.

Threaded fitting 18 includes an outlet opening which may convey filtered fluid to an engine such as by way of an engine oil pump in some instances. Filter assembly 10 may further include a plurality of inlet openings 22 arranged circumferentially around threaded fitting 18 to receive an incoming flow of unfiltered fluid for filtering in filter assembly 10. A peripheral rim 26 extends circumferentially around threaded fitting 18 and inlet openings 22. A seal 24 may be positioned inwardly of peripheral rim 26 and seals against supporting structure with which threaded fitting 18 in engaged. In other embodiments, different inlet and outlet configurations could be used, including one or more outlets located outwardly of a centrally located inlet, approximately the reverse of what is depicted in FIG. 1. It should be appreciated that the present disclosure is not limited with regard to direction of flow, number of inlets, number of outlets. An outer surface 28 of filter component 14 may be configured with a plurality of planar faces for gripping by a service technician or tool engagement in some embodiments.

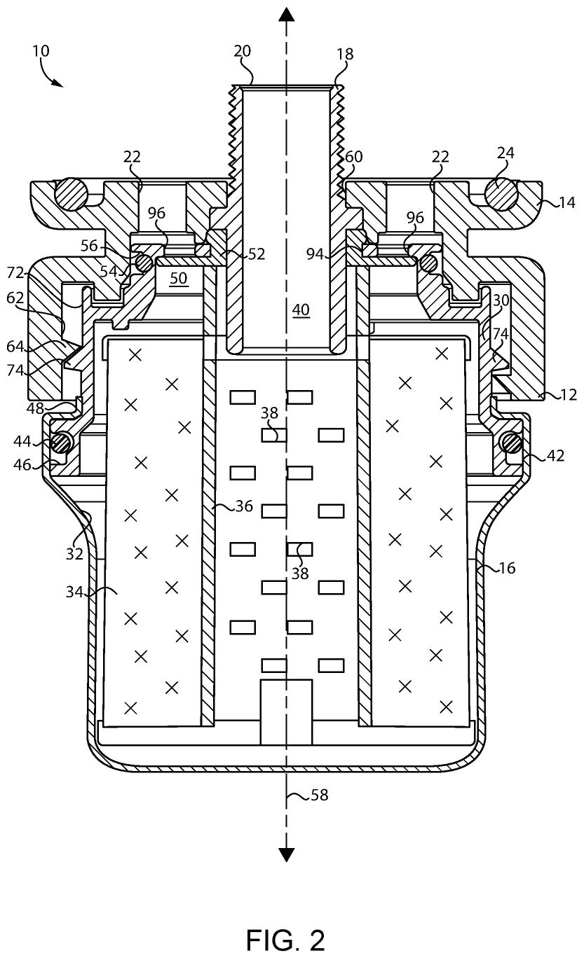

Referring also now to FIG. 2, there are shown additional features including internal structures of filter assembly 10 in some detail. A cavity 32 is formed in filter component 16 and receives a filter element 34 at least partially therein to be positioned fluidly between one or more unfiltered fluid inlets and one or more filtered fluid outlets, either of which can be configured as one or more central openings or one or more radially outward openings as discussed herein. Filter element 34 may include a filter medium surrounding a center tube 36. A plurality of perforations or holes 38 may be formed in center tube 36 to convey a flow of filtered fluid into center tube 36 and thenceforth to an outlet passage extending to outlet opening 20. Filter component 16 may also include a flared wall 42 that extends outwardly and then curves inwardly to a lip 48. A seal 44, such as an O-ring seal, may be positioned to seal between wall 42 and a connector piece 30 and seated within a seal groove 46. As further discussed herein connector piece 30 is considered a “filter component” within the context of the present disclosure.

One or more inlet passages 50 extend between inlet openings 22 and cavity 32 to convey a flow of unfiltered fluid to filter element 34. In the illustrated embodiment inlet passages 50 extend through a perforated disk 52 within which threaded fitting 18 is positioned. Another seal 54 may be positioned within another seal groove 56 formed in filter component 30 to seal between filter component 30 and filter component 14.

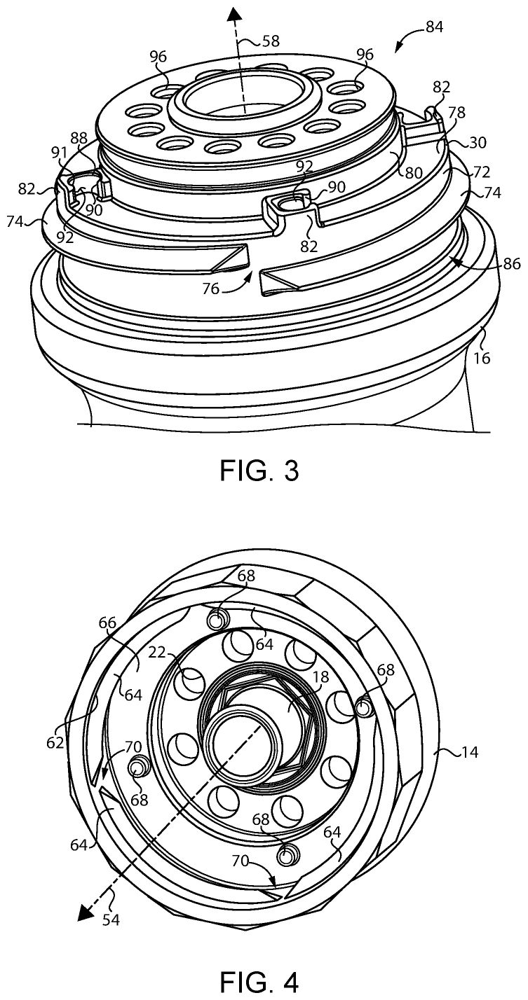

Referring also now to FIGS. 3 and 4, filter component 14 defines a center axis 58 and includes a central opening 60 formed therein and centered on center axis 58. As components of filter assembly 10 may be coaxially arranged it should be appreciated that center axis 58 may be a longitudinal center axis shared by multiple components including filter component 14, filter component 16, and filter component 30. Directional descriptors used herein including axial or axially, radial or radially, circumferential or circumferentially, axial direction, radial direction, circumferential direction, are to be understood in reference to and defined by center axis 58. Further, for convenience of description filter component 14 may be referred to as a first filter component or a connector piece, filter component 30 may be referred to as a second filter component or connector piece, and filter component 16 may be referred to, as times, as a container piece. The use of terms first, second, and like descriptors are not used in a limiting sense, and depending upon perspective, filter component 14 might be a first component or a second component, component 30 might be a first component or a second component, and so on.

First filter component 14 includes a first threaded peripheral surface 62 circumferential of center axis 58. First threaded peripheral surface 62 may be an inner peripheral surface as shown in FIG. 4. In other instances, first threaded peripheral surface 62 might be an outer peripheral surface. Surface 62 includes threads 64 thereon. Threads 64 may include multi-start threads, in the embodiment shown in FIG. 4 defining a plurality of thread start locations 70. In a practical implementation threads 64 may include a total of four internal threads defining a total of four thread start locations 70.

First filter component 14 further includes a radially extending surface 66, and a plurality of posts 68 projecting from radially extending surface 66 in an axial direction. Post 68 may be spaced radially inward and spaced axially from first threaded peripheral surface 62. In an implementation, posts 68 may be cylindrical. Posts 68 could have a variety of other forms including partially cylindrical, oval or partially oval, or polygonal forms in some embodiments.

Second filter component 30 includes a second threaded peripheral surface 72 structured to engage first threaded peripheral surface 62. Second threaded peripheral surface 72 may include an outer peripheral surface, although embodiments are contemplated where second threaded peripheral surface 72 is an inner peripheral surface. Second filter component 30 further includes threads 74 upon second threaded peripheral surface 72. Threads 74 may also include multi-start external threads defining a plurality of thread start locations 76. Second filter component 30 may also include a radially extending surface 78 and an axially extending surface 80 adjoining radially extending surface 78. Radially extending surface 78 may extend from axially extending surface 80 to second threaded peripheral surface 72. Second filter component 30 also includes a plurality of detent clips 82. Detent clips 82 are structured to engage post 68 in a manner further discussed herein, and are matched to posts 68 in number and in angular spacing around center axis 58.

Second filter component 30 or filter connector piece 30 is also understood to define center axis 58 as discussed above. Center axis 58 extends between a first axial connector end 84 and a second axial connector end 86. First axial connector end 84 is understood to include threaded peripheral surface 72, radially extending surface 78, and axially extending surface 80, as well as detent clips 82. Detent clips 82 may be attached to at least one of radially extending surface 78 or axially extending surface 80. In a practical implementation detent clips 82 are attached to both radially extending surface 78 and axially extending surface 80, and each extend radially outward to threaded peripheral surface 72.

Focusing on FIG. 3, detent clips 82 each include a detent surface 88 extending linearly in an axial direction, and being contoured radially so as to form a radially projecting engagement bump 90 and a retention pocket 92 circumferentially adjacent to radially projecting engagement bump 90. Each detent surface 88 may be contoured so to form radially projecting engagement bump 90 radially projecting in a radially outward direction. Each respective pocket 92 may be formed at least in part by a concave section of the respective detent surface 88. Each detent surface 88 may also be contoured radially so as to form a second radially projecting engagement bump 91 positioned in opposition to first radially projecting engagement bump 90. First radially projecting engagement bump 90 and second radially projecting engagement bump 91 may define an opening to the respective retention pocket 92 therebetween. Also in a practical implementation each of detent clips 82 defines a C-shape of retention pocket 92 that opens in a circumferential direction. Each respective retention clip 82 is further understood to open in an axial direction and in a circumferential direction.

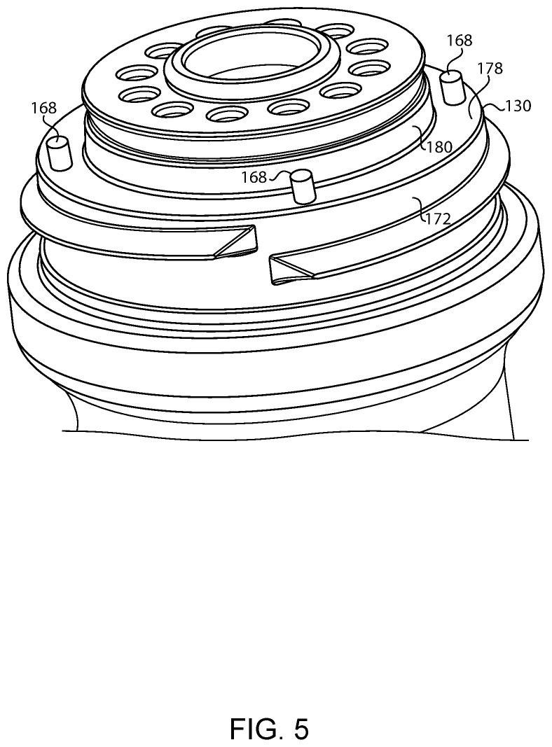

Referring now to FIG. 5, there is shown a filter component 130 similar to the filter component shown in FIG. 3 and including a threaded peripheral surface 172, a radially extending surface 178, and an axially extending surface 180. In contract to the embodiment of FIG. 3, filter component 130 includes a plurality of posts 68 instead of a plurality of detent clips. In can thus be appreciated that filter component 130 might be substantially identical to filter component 30 but for the positioning of posts 168 on the filter component that includes a serviceable filter element. Thus, filter component 130 could be used with a counterpart filter component similar to filter component 14 shown in FIG. 4 but having detent clips in place of the posts. Those skilled in the art will thus appreciate that the embodiment of FIG. 5 may represent an approximate reversal of which component includes posts and which components includes detent clips. In filter component 130 posts 168 project from radially extending surface 178 in an axial direction, and are positioned at a radially extending clearance from axially extending surface 180 as illustrated.

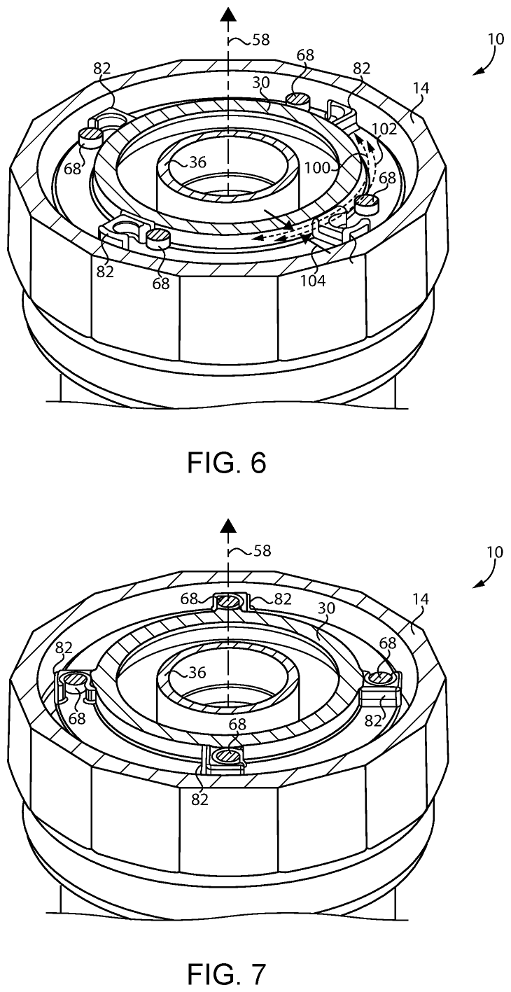

Referring again to the embodiment of FIGS. 2-4, but also now referring to FIG. 6, there is shown filter assembly 10 at one stage of installation but prior to click-lock engagement of detent clips 82 with posts 68. As also illustrated in FIG. 6, the plurality of posts 68 define a first circle 100 centered on center axis 58. First circle 100 may be defined by radially innermost points of posts 68. The plurality of detent clips 82 define a second circle 102 also centered on center axis 58. Second circle 102 may be defined by radially outermost points of detent clips 82, such that second circle 102 is radially outward of first circle 100. An analogous description could be employed relative to posts 68 and engagement bumps 91. In other words, radially innermost points of engagement bumps 91 can be described as defining a circle that is radially inward of another circle defined by radially outermost points of posts 68. A post-detent interference distance 105 is defined along a radial direction between first circle 100 and second circle 102. At least one of, the plurality of posts 68 or the plurality of detent clips 82, is deformable via relative rotation of detent clips 82 together as a group about center axis 58 in contact with posts 68. Put differently, at least one of posts 68 or detent clips 82 can be deformed in a radial direction by respective contact between posts 68 and detent clips 82 to urge posts 68 past engagement bumps 90 and 91 to click-lock engage detent clips with posts 68. The described deformation reduces post-detent interference distance 105. Either or both of first filter component 14 and second filter component 30 could be rotated to perform the click-lock engagement. As can be seen in FIG. 7, posts 68 are engaged with detent clips 82. Detent clips 82 having been deformed in the radial direction via relative rotation from the arrangement shown in FIG. 6 to seat posts 68 within pockets 92, and then at least partially returned in an opposite radial direction. When the transition from the FIG. 6 configuration to the FIG. 7 configuration is performed by a technician, tactile feedback as well as potentially an audible click can be experienced to inform the technician that filter assembly 10 is properly assembled for service. Reversing the transition and going from FIG. 7 to FIG. 6 can also produce tactile and/or audible feedback in at least some instances.

It will also be appreciated that threads 64 and 74 are engaged in the state shown in FIGS. 6 and 7. The provision of multi-start threads enables a user to commence installation by inserting one filter component into another at a plurality of different relative angular orientations. Moreover, based upon a number of thread start locations and a number of posts 68 and detent clips 82 a technician can complete installation by way of an approximately one quarter turn around center axis 58. In a practical implementation, a number of the plurality of detent clips 82 and the plurality of posts 68 may be an integer multiple of two. In a further practical implementation, the number may be 4. A number of the plurality of thread start locations in the filter component equipped with detent clips may be two. Two of the four detent clips may each be offset in a circumferential direction approximately 45 degrees from each of the two thread start locations. The term approximately is to be understood herein as meaning generally or substantially, as would be recognized by one of ordinary skill in the art. For instance, a turn that is closer to a one-quarter turn than to a half turn would be understood as approximately a one-quarter turn. A number of the plurality of detent clips and posts may vary as discussed herein, however, the plurality of detent clips 82 and posts will typically be equiangularly spaced around center axis 58.

### INDUSTRIAL APPLICABILITY

As described above, filter assembly 10 and other filter assemblies contemplated herein may be provided as a replacement filter swapped for a dirty or used filter in a machine system. In other instances filter assembly 10 could be sold installed on an engine or other machine, sold as a separate complete filter assembly or part of a fluid system including as a retrofit system. Filter media used in filter assembly 10 can be of conventional types. Filter components can be made of a suitable molded plastic, such as an injection molded plastic material or by way of additive manufacturing.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A filter assembly for a fluid system comprising:
a first filter component defining a center axis, and including a first threaded peripheral surface circumferential of the center axis, a radially extending surface, and a plurality of posts projecting from the radially extending surface in an axial direction;
a second filter component including a second threaded peripheral surface structured to engage the first threaded peripheral surface, and a plurality of detent clips matched to the plurality of posts in number and in angular spacing around the center axis;
the plurality of posts defining a first circle centered on the center axis, the plurality of detent clips defining a second circle centered on the center axis, and a post-detent interference distance is defined along a radial direction between the first circle and the second circle; and
at least one of, the plurality of posts or the plurality of detent clips, is deformable via relative rotation of the plurality of detent clips together about the center axis in contact with the plurality of posts to click-lock engage the plurality of detent clips with the plurality of posts.

2. The filter assembly of claim 1 wherein the at least one of, the plurality of posts or the plurality of detent clips, is deformable in the radial direction via the relative rotation to reduce the post-detent interference distance.

3. The filter assembly of claim 2 wherein each of the plurality of detent clips forms a pocket opening in the axial direction and in a circumferential direction.

4. The filter assembly of claim 3 wherein each of the pockets is C-shaped, and each of the plurality of posts is cylindrical.

5. The filter assembly of claim 1 wherein the number of the plurality of detent clips and the plurality of posts is an integer multiple of two.

6. The filter assembly of claim 5 wherein the number is four.

7. The filter assembly of claim 6 wherein each of the first threaded peripheral surface and the second threaded peripheral surface defines a plurality of thread start locations.

8. The filter assembly of claim 7 wherein a number of the plurality of thread start locations is two, and wherein two of the four detent clips are each offset in a circumferential direction approximately 45 degrees from each of the two thread start locations.

9. A filter component comprising:
a filter connector piece defining a center axis extending between a first axial connector end and a second axial connector end;
the first axial connector end including a threaded peripheral surface including threads thereon, a radially extending surface, an axially extending surface, and a plurality of detent clips attached to at least one of the radially extending surface or the axially extending surface; and
the plurality of detent clips each including a detent surface extending linearly in an axial direction, and contoured radially so as to form a radially projecting engagement bump and a retention pocket circumferentially adjacent to the radially projecting engagement bump.

10. The filter component of claim 9 wherein the first axial connector end has formed therein a central opening centered on the center axis, and at least one radially outward opening.

11. The filter component of claim 10 further comprising a filter medium positioned at least partially in the filter housing and fluidly between the central opening and the at least one radially outward opening.

12. The filter component of claim 9 wherein the threaded peripheral surface includes an outer peripheral surface, and each detent surface is contoured so as to form the radially projecting engagement bump projecting in a radially outward direction.

13. The filter component of claim 12 wherein the threads include multi-start external threads.

14. The filter component of claim 13 wherein a number of the plurality of detent clips is an integer multiple of two and the plurality of detent clips are equiangularly spaced around the center axis.

15. The filter component of claim 14 wherein:
the threads define a total of two thread start locations, and the number of the plurality of detent clips is four; and
two of the four detent clips are each offset in a circumferential direction approximately 45 degrees from each of the two thread start locations.

16. The filter component of claim 9 wherein the plurality of detent clips are attached to both the radially extending surface and the axially extending surface, and are offset in the axial direction from the threads.

17. The filter component of claim 16 wherein each respective pocket is formed at least in part by a concave section of the detent surface.

18. The filter component of claim 9 wherein each of the detent surfaces is contoured radially so as to form a second radially projecting engagement bump positioned in opposition to the first radially projecting engagement bump, and the first radially projecting engagement bump and the second radially projecting engagement bump defining an opening to the pocket therebetween.

19. The filter component of claim 18 wherein each of the detent clips defines a C-shape that opens in a circumferential direction.

20. A filter component comprising:
a filter housing including a container piece and a filter connector piece;
a filter medium positioned at least partially in the container piece;
the filter connector piece defining a center axis extending between a first axial connector end and a second axial connector end;
the first axial connector end including a threaded peripheral surface including multi-start threads thereon, a radially extending surface, and an axially extending surface; and
the filter connector piece further including a plurality of posts projecting from the radially extending surface in an axial direction, and positioned at a clearance from the axially extending surface.
